(19) United States
(12) Patent Application Publication
(10) Pub. No.: US 2025/0283618 A1
(43) Pub. Date: Sep. 11, 2025

(54) Service Network System for an Operating Theatre

(71) Applicant: Merit Group Services Limited, Northumberland (GB)

(72) Inventor: Anthony WELLS, Northumberland (GB)

(21) Appl. No.: 18/672,028

(22) Filed: May 23, 2024

(30) Foreign Application Priority Data
Mar. 6, 2024 (GB) 2403302.9

(51) Int. Cl. F24F 3/16; F24F 7/04; F24F 13/02

(52) U.S. Cl. CPC F24F 3/16; F24F 7/04; F24F 13/0272

(57) ABSTRACT

A service network system 1, for providing services to an operating theatre facility 3, comprising, an air handling unit 19, an interface pre-assembled module 13, a receiver pre-assembled module 11, an operating theatre pre-assembled module 9, ventilation supply ductwork 50,55,77 and ventilation return ductwork 52,57,79. The ventilation supply ductwork 50, 55,77 and ventilation return ductwork 52, 57,79 pass from the air handling unit 9 then through the interface pre-assembled module 13, then through the receiver pre-assembled module 11 and then into the operating theatre pre-assembled module 9.

### TECHNICAL FIELD

The present invention relates to a service network system for a traditionally built operating theatre or for a modular operating theatre and in particular to a service network system for an operating theatre provided with an ultra-clean ventilation system. The utility requirements for these areas are complex and require a streamlined solution to reduce the construction time.

### BACKGROUND

The construction industry is known to have a chronically low level of productivity that has changed very little in the past seventy years. It is thought that the low level of productivity is a consequence of the generally accepted need for bespoke buildings to be developed for particular applications combined with ‘tried-and-tested’ construction methods.

Bespoke buildings can take several years to design, construct and validate which is slow and by implication costly. Furthermore, building designs are also often subject to changes as a project progresses and, in some circumstances, buildings must be further modified after completion to comply with a change in requirements, expansion or cost constraints.

The problem is particularly acute for research and medical facilities which often need to be constructed rapidly and which must be flexible to accommodate changes to their end use. For example, laboratory facilities such as vaccine development facilities, advanced therapy medicinal product facilities and cell and gene therapy facilities are often planned and initiated very quickly, with a need for them to be constructed and commissioned in several months rather than several years and to be adaptable during and after construction.

In addition, once a building has been constructed, it is typically time consuming and costly to install service networks of conveying components, such as ventilation systems, piping networks and electrical networks, in the building.

It can be desirable to locate plant equipment, such as HVAC systems, electrical generators and the like, on the roof of a facility rather than inside a facility. This can save space, provide easier access to plant equipment for installation, maintenance and inspection purposes, and make it easier to reconfigure the facility by adding, removing or replacing plant equipment as needed.

However, locating plant equipment on the roof of a facility can have several disadvantages. It can increase project cost, complexity and duration by requiring a bespoke design and installation to connect plant equipment with services on the roof and to the service network inside the facility. It can also make the facility less easily reconfigurable.

There is a need to provide a modular building system that addresses some or all of the above-described disadvantages. In relation to the present invention, the modular building system approach is used to provide a modular operating theatre.

### SUMMARY OF THE INVENTION

In accordance with a first aspect of the invention there is provided a service network system, for providing services to an operating theatre facility, comprising, an air handling unit, an interface pre-assembled module, a receiver pre-assembled module, an operating theatre pre-assembled module, ventilation supply ductwork and ventilation return ductwork, wherein the ventilation supply ductwork and ventilation return ductwork pass from the air handling unit then through the interface pre-assembled module, then through the receiver pre-assembled module and then into the operating theatre pre-assembled module. This arrangement is advantageous because it avoids having to build services on site, which is inevitably time consuming and costly. In addition, providing a receiver pre-assembled structure that is separate to an operating theatre pre-assembled structure facilitates road transportation of the service network system from its manufacturing location to the site where it will be installed.

Preferably, the operating theatre facility is located within a building and wherein the air handling unit is located outside of the building, the interface pre-assembled module is located in an external surface of the building such that it has a first part that is located outside of the building and a second part that is located inside of the building, the receiver pre-assembled module is located within the building and the operating theatre pre-assembled module is located within the building, wherein the ventilation supply ductwork and ventilation return ductwork pass through the interface pre-assembled module. The provision of a pre-assembled interface module is advantageous because it facilitates passing of all of the services through the external fabric of the building through a single aperture.

Preferably, the air handling unit is located on the roof of the building and vertically above the operating theatre pre-assembled module, wherein the operating theatre pre-assembled module and the receiver pre-assembled module are located adjacent to each other and the ventilation supply ductwork and the ventilation return ductwork run laterally between the operating theatre pre-assembled module and the receiver pre-assembled module. This facilitates the routing of all of the ventilation ductwork through the pre-assembled interface module, thus avoiding having to make multiple apertures through the roof of the building.

Preferably, the interface pre-assembled module is a lid pre-assembled module.

Preferably, the operating theatre pre-assembled module is provided with an ultra-clean ventilation canopy opening and HVAC supply ductwork for connection to an ultra-clean ventilation canopy.

Preferably, an ultra-clean canopy is provided within the ultra-clean ventilation canopy opening and is connected to the HVAC supply ductwork.

Preferably, all services provided to the operating theatre pre-assembled module pass through a vertical face of the operating theatre pre-assembled module.

Preferably, all of the services that are provided to the operating theatre pre-assembled module pass through the receiver pre-assembled module.

Preferably, the operating theatre pre-assembled module is provided with a lamp pendant support.

Preferably, the operating theatre pre-assembled module is provided with a first pendant support, a second pendant support and a third pendant support. The provision of first, second and third pendant supports in the operating theatre pre-assembled module is advantageous because it gives the designer of an operating theatre flexibility about where to locate the pendants (typically only two pendants are needed) and it removes the need to access the operating theatre pre-assembled module after assembly to mount the pendant supports (such access not always being available).

Preferably, the receiver pre-assembled module and the operating theatre pre-assembled module each comprise an open framework.

Preferably, the service network system is for providing services to an ultra-clean operating theatre facility.

According to a second aspect of the present invention, there is provided a service network system in combination with an operating theatre facility.

According to a third aspect of the present invention, the operating facility comprises a separable operating theatre pod and a separable auxiliary rooms pod.

According to a fourth aspect of the present invention, there is provided a service network system in combination with an ultra-clean operating theatre facility.

Preferably, the ultra-clean operating facility comprises a separable operating theatre pod and a separable auxiliary rooms pod.

### BRIEF DESCRIPTION OF THE DRAWINGS

Embodiments of the present invention will now be described by way of example only with reference to the accompanying drawings where like parts are provided with corresponding reference numerals and in which:

FIG. 1 is a perspective schematic view of a service network system in combination with a traditionally built operating theatre facility;

FIG. 2 is an elevation schematic view of the service network system and operating theatre facility of FIG. 1;

FIG. 3 is a perspective schematic view of an air handling unit (AHU) that forms part of the service network system of FIG. 1;

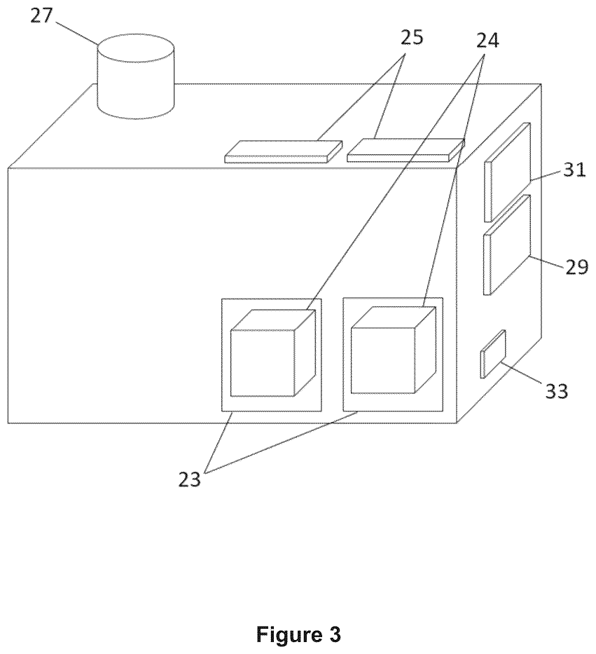

FIG. 4 is a perspective schematic view of a roof pre-assembled module (PAM) that forms part of the service network system of FIG. 1;

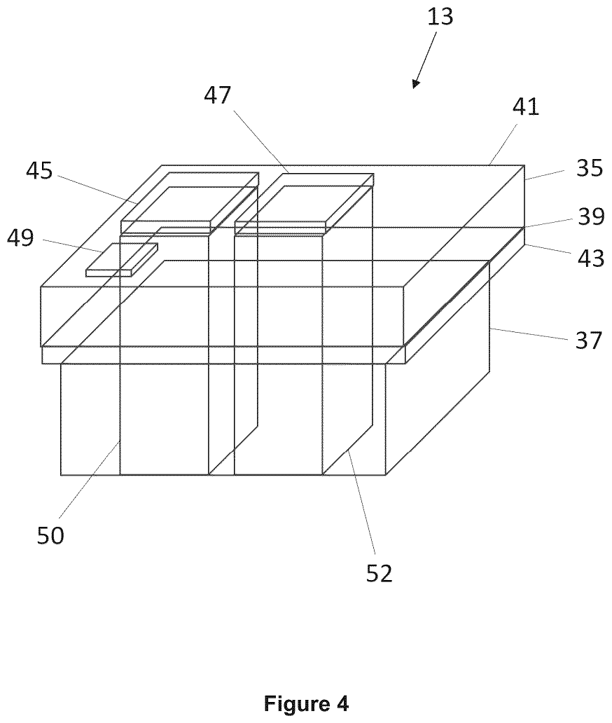

FIG. 5 is a perspective schematic view of a receiver pre-assembled module (PAM) that forms part of the service network system of FIG. 1;

FIG. 6 is a perspective schematic view of a roof PAM header that forms part of the service network system of FIG. 1; and

FIG. 7 is a perspective schematic view of an operating theatre pre-assembled module (PAM) that forms part of the service network system of FIG. 1;

FIG. 8 is a schematic plan view of the service network system of FIG. 1; and

FIG. 9 is a perspective schematic view of a service network system in combination with a modular operating theatre facility.

### DETAILED DESCRIPTION

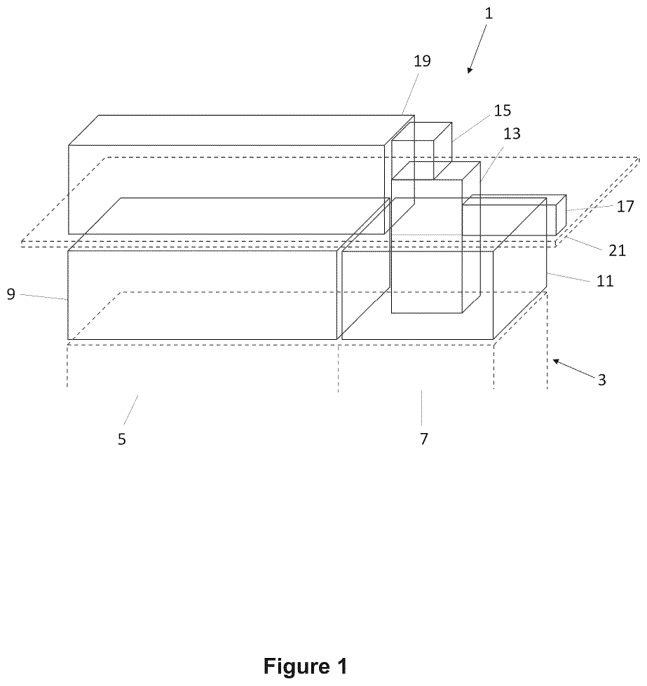

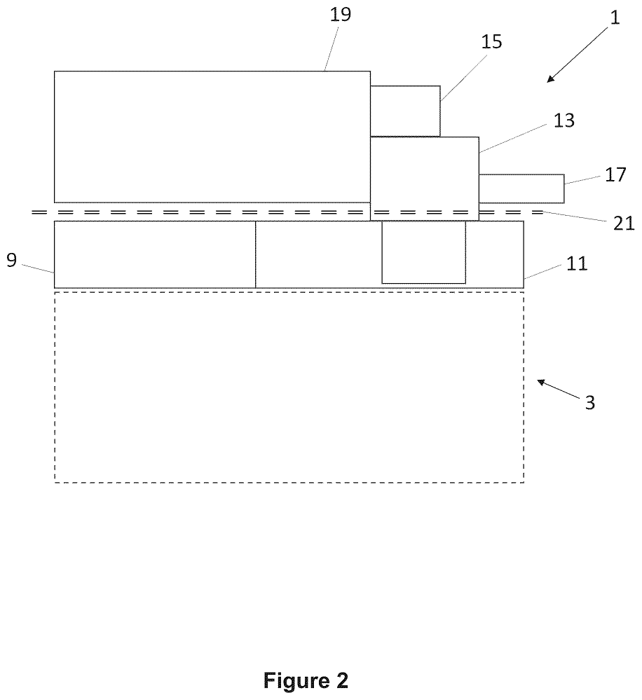

FIGS. 1 and 2 are schematic views of a service network system 1 according to an embodiment of the present invention for providing services to an ultra-clean operating theatre facility 3 that is located within a larger building, typically a hospital. The service network system 1 is also suitable for the provision of services to conventional operating theatre facilities, e.g. those that are not provided with ultra-clean ventilation systems. The services provided by the service network system 1 are, for example, ventilation (supply and extraction), electrical power and electrical control signals, water and medical gasses.

The operating theatre facility 3 is one built using traditional construction methods and comprises an operating theatre 5 and auxiliary rooms 7. The auxiliary rooms 7 are typically a preparation/layup room, an anaesthetic room and a scrub/gown room.

The service network system 1 comprises an operating theatre pre-assembled module (PAM) 9, a receiver pre-assembled module (PAM) 11, a lid pre-assembled module (PAM) 13, a roof pre-assembled module (PAM) 15, a low-level header 17 and an air handling unit (AHU) pod 19. The operating theatre PAM 9, the receiver PAM 11 and the AHU pod 19 are all cuboidal in form s and the lid PAM 13 is generally cuboidal.

The various components of the service network system 1 and the operating theatre facility 3, e.g. the operating theatre facility rooms, the pods, modules and headers, each have an upper face and a lower face. The upper faces face upwards in use and the lower faces face downwards in use, for example as illustrated in FIG. 1. The components also have a front face, which is the face located to the front in FIG. 1 (i.e. facing out of the page), a back face, which is the face located to the back in FIG. 1, a left-hand side face, which is the face located on the left-hand side in FIG. 1, and a right-hand side face, which the face located on the right hand side in FIG. 1.

In this embodiment of the present invention an upper part of the service network system 1 is provided above a roof 21 of a building, a lower part of the service network system 1 is provided below the roof 21 and an interface part of the service network system 1 passes through the roof 21 to connect the upper part to the lower part. The lid PAM 13 provides the interface part between the upper part and lower parts.

The upper part of the service network system 1 comprises the AHU pod 19, the roof PAM 15 and the low-level header 17. The lower part of the service network system 1 comprises the operating theatre PAM 9 and the receiver PAM 11. The lid PAM 13 is located between the roof PAM 15 and the receiver PAM 11 in order to connect the upper part of the service network system 1 to the lower part.

The operating theatre PAM 9 is located directly above the operating theatre 5 of the operating theatre facility 3. In plan view, the operating theatre PAM 9 has the same shape as the operating theatre 5, i.e. it is rectangular, with a length, left to right, that is greater than its width, front to back. The height of the operating theatre PAM 9 is significantly lower than the height of the operating theatre facility 3. In this example the length of the operating theatre PAM 9 is 7.3 m, the width is 4.8 m, the height of the operating theatre PAM 9 is 0.8 m and the height of the operating theatre 5 is 4.2 m.

The operating theatre PAM 9 is adjacent to and connected with the receiver PAM 11 and the receiver PAM 11 is located directly above the auxiliary rooms 7. In plan view, the receiver PAM 11 has the same shape as the auxiliary rooms 7, i.e. it is rectangular, with a length, left to right, that is greater than its width, front to back. The height of the receiver PAM 11 is significantly lower than the height of the auxiliary rooms 7 serving the operating theatre 5. In this example the length of the receiver PAM is 8.1 m, the width is 4.4 m, the height of the receiver PAM 11 is 0.9 m and the height of the auxiliary rooms 7 are 4.2 m. The operating theatre PAM 9 and the receiver PAM 11 are provided with different dimensions in order to meet each of their different requirements. In this embodiment the height of the operating theatre PAM 9 is lower than that of the receiver PAM 11 because the size of the void above the operating theatre 5 is smaller.

The lid PAM 13 is located beneath the roof PAM 15, partially above the receiver PAM 11 and partially within the receiver PAM 11. In plan view, the lid PAM 13 has a length and width that is less than the receiver PAM 11.

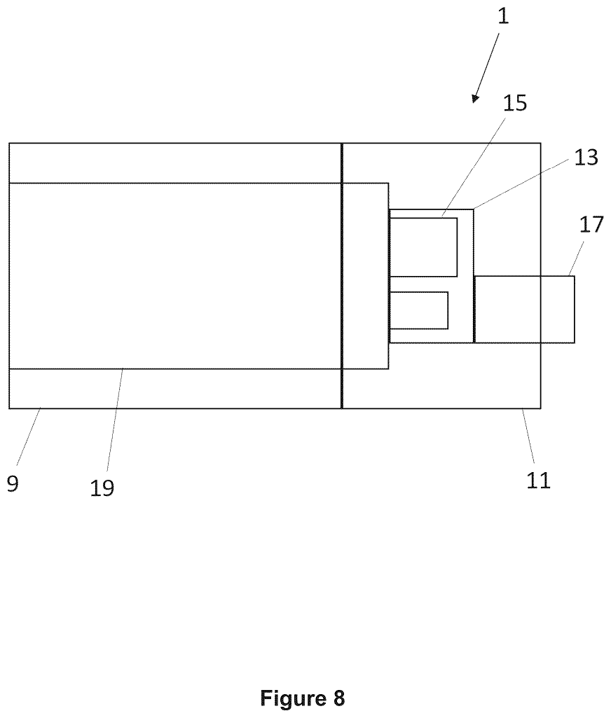

The AHU pod 19 is located above and extends over the operating theatre PAM 9 and is located above and extends partially over the receiver PAM 11. The AHU pod 19 is located adjacent to the lid PAM 13 and to the roof PAM 15. The left-hand end of the AHU pod 19 and the left-hand end of the operating theatre PAM 9 are located within the same vertical plane. The AHU pod 19 has a width, front to back, that is less than the width of the operating theatre PAM 9, such that the front and back faces of the AHU pod 19 and the operating theatre PAM 9 are located in different vertical planes, for example as shown in FIG. 8.

The AHU pod 19 is arranged to handle the air being supplied to and being extracted from the operating theatre facility 3. It can, for example, supply cooled and filtered air to the operating theatre 5. The heating and cooling requirements for the AHU pod 19 are provided by heat pumps 24. Air flow to the heat pumps 24 is provided through heat pump air inlets 23 and is rejected through heat pump air outlets 25. An air exhaust 27 is provided for rejection from the AHU pod 19 of the air extracted from the operating theatre 5 and the auxiliary rooms 7. The AHU pod 19 provides heating ventilation and air conditioning (HVAC) through a HVAC supply connection 29, and through a HVAC return connection 31 to the operating theatre 5 and the auxiliary rooms 7. A services connection 33, is used for example for the connection of electrical power and electrical signal cables within the AHU POD 19. The present invention facilitates the use of pre-assembled wiring looms to facilitate the provision of electrical data services and electrical power throughout the service network system 1.

The lid PAM 13 provides a means for distributing conveying components, such as electrical cables or fluid ducting, through the roof 21 of the building, so that the conveying components can be connected between apparatus located inside the building and apparatus located outside of the building, for example on the roof 21. The lid PAM 13 thus provides a connection through the roof 21 of the building to connect the AHU pod 19 to the receiver PAM 11.

The lid PAM 13 comprises a lid plate 35 and a riser frame 37 that extends downwardly from the lid plate 35. The lid plate 35 is a flat plate comprising a lower surface 39 and an upper surface 41. A seal 43 is provided on the lower surface 39 and, in use, contacts the upper surface of the roof 21. The upper surface 41 of the lid 35 is provided with apertures to receive conveying components. It is provided with a HVAC supply connection 45, a HVAC return connection 47 and a services connection 49. HVAC supply ductwork 50 and HVAC return ductwork 52 run downwardly through the lid PAM 13 from the HVAC supply connection 45 and the HVAC return connection 47 respectively.

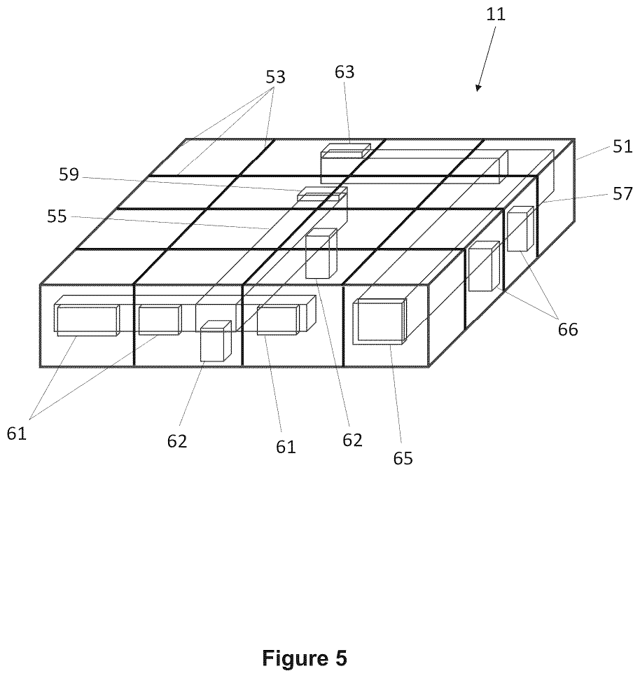

The receiver PAM 11 is shown, for example, in FIG. 5. It receives conveying components from the lid PAM 13 and comprises an open framework 51 made up from a lattice of steel members 53. The framework 51 is in the form of a cuboid that has a relatively small depth as compared to its length and width. HVAC supply ductwork 55 and HVAC return ductwork 57 is located within and supported by the framework 51. The supply ductwork 55 is provided with a HVAC supply connection 59 that is located on the upper face of the receiver PAM 11 and three HVAC intermediate connections 61, which are for connection to the operating theatre PAM 9. The three HVAC intermediate connections 61 are located on the left-hand side face of the receiver PAM 11 (i.e. the face facing out of the page in FIG. 5). The supply ductwork 55 has a plurality of outlet ducts 62 which have outlet vents which are located on the lower, left-hand, front, back, or right-hand face of the receiver PAM 11 and which, in use, provide a supply of filtered air to regions within the auxiliary rooms 7. It is envisaged that one or more outlet vents can be provided on just one face, for example, just on the lower face, or on more than one face. The HVAC supply connection 59 is connected to the HVAC supply ductwork 50 of the lid PAM 13. The return ductwork 57 is provided with a HVAC return connection 63 that is located on the upper face of the receiver PAM 11 and an HVAC intermediate connection 65 which is located on the left-hand side face of the receiver PAM 11. The return ductwork 57 has a plurality of extraction ducts 66 which have extraction vents located on the lower, front, left-hand, right-hand or back face of the receiver PAM 11 and which, in use, extract air from regions within the auxiliary rooms 7. It is envisaged that one or more extraction vents can be provided on just one face, for example, just on the lower face, or on more than one face. The HVAC return connection 63 is connected to the HVAC return ductwork 52 of the lid PAM 13.

In addition to accommodating the HVAC supply and return ductwork 55, 57, the framework 51 of the receiver PAM 11 also accommodates the other services that are provided by the service network system 1. For example, electrical cables, and gas and liquid pipework can pass into the receiver PAM 11 via the services intermediate connection 49 of the lid PAM 13, and then can pass out of the receiver PAM 11, either downwardly into the auxiliary rooms 7, through its lower face, or laterally into the operating theatre PAM 9, through its left-hand face.

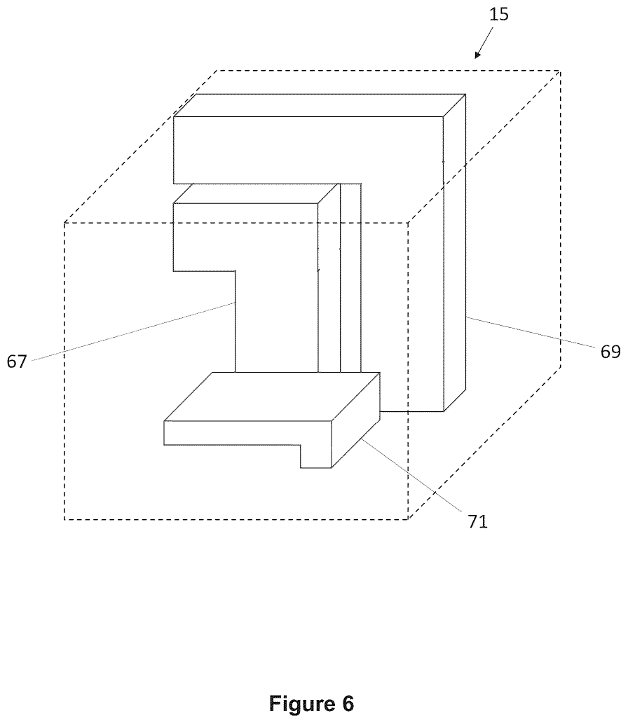

The roof PAM 15, for example as shown in FIG. 6, comprises HVAC supply ductwork 67 that runs between the HVAC supply connection 31 on the AHU pod 19 and the HVAC supply connection 45 on the lid PAM 13, HVAC return ductwork 69 that runs between the HVAC return connection 31 on the AHU pod 19 and the HVAC return connection 47 on the lid PAM 13 and a services conduit 71 that runs between the services connection 33 of the AHU pod 19 and the services intermediate connection 49 on the lid PAM 13.

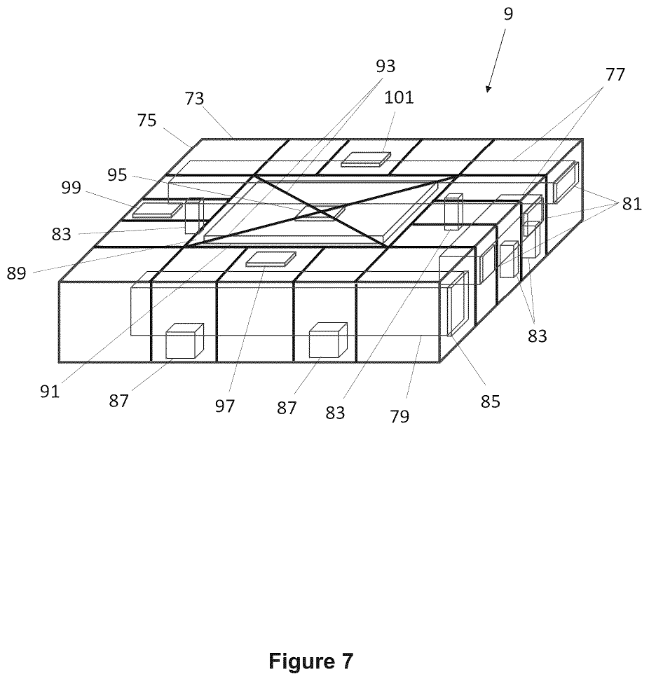

The operating theatre PAM 9, for example as shown in FIG. 7, comprises an open framework 73 made up from a lattice of steel members 75. The framework 73 is in the form of a cuboid that has a relatively small depth as compared to its length and width. HVAC supply ductwork 77 and HVAC return ductwork 79 is located within and supported by the framework 73.

The supply ductwork 77 is provided with three HVAC intermediate connections 81 that are located on the right-hand face of the operating theatre PAM 9 and that are for connecting to the HVAC intermediate connections 61 on the receiver PAM 11. The supply ductwork 77 has a plurality of outlet ducts 83 which have outlet vents which are located on the lower, front, back, left-hand or right-hand face of the operating theatre PAM 9 and which, in use, provide an ultra-clean supply of air to regions within the operating theatre 5, as will be explained in further detail below. It is envisaged that one or more outlet vents can be provided on just one face, for example, just on the lower face, or on more than one face.

The return ductwork 79 is provided with a HVAC intermediate connection 85 that is located on the right-hand face of the operating theatre PAM 9 and that is for connecting to the HVAC intermediate connection 65 on the receiver PAM 11. The return ductwork 79 has a plurality of extraction ducts 87 which have extraction vents located on the lower, front, back, left-hand or right-hand face of the operating theatre PAM 9 and which, in use, extract air from regions within the operating theatre 5. It is envisaged that one or more extraction vents can be provided on just one face, for example, just on the lower face, or on more than one face.

In addition to accommodating the HVAC supply and return ductwork 77, 79, the framework 73 of the operating theatre PAM 9 also accommodates the other services that are provided by the service network system 1 and which have already passed through the receiver PAM 11, for example, electrical cables, and gas and liquid pipework. Those other services then pass downwardly into the operating theatre 5, through the lower face of the operating theatre PAM 9.

The steel members 75 of the framework 73 of the operating theatre PAM 9 are arranged to produce a square ultra-clean ventilation (UCV) canopy opening 89 at its centre, within which is cradled a UCV canopy 91. The HVAC supply ductwork 77 of the operating theatre PAM 9 is connected to the UCV canopy 91, such that, in use, the UCV canopy 91 can create an air curtain around an operating table that is located within the operating theatre 5.

The framework 73 is provided with two steel diagonal cross-members 93 that run across the UCV canopy opening 89 from opposite corners and which, at the point where they cross, provide a mounting for a lamp pendant support 95 at the centre of the UCV canopy 91 for a lamp (not shown) that is located above an operating table within the operating theatre 5.

The operating theatre PAM 9 is further provided with a first pendant support 97, that is located towards the front face of the operating theatre PAM 9, a second pendant support 99, that is located towards the left-hand face of the operating theatre PAM 9 and a third pendant support 101, that is located towards the back face of the operating theatre PAM 9.

In use, conditioned air can be supplied to the UCV canopy 91 from the AHU pod 19 via the HVAC supply ductwork provided by the various components of the service network system 1. Air passes out of the AHU pod 19 through its HVAC supply connection 29, through the HVAC supply ductwork 67 of the roof PAM 15, through the HVAC supply ductwork 50 of the lid PAM 13, through the HVAC supply ductwork 55 of the receiver PAM 11 and then through the HVAC supply ductwork 77 of the operating theatre PAM 9. Conditioned air can also be supplied to the auxiliary rooms 7 via the outlet ducts 62 provided in the receiver PAM 11.

Air can be extracted from the operating theatre of the operating theatre facility 3 via the extraction ducts 87 provided in the HVAC return ductwork 79 in the operating theatre PAM 9. The extracted air passes through that HVAC return ductwork 79, through the HVAC return ductwork 57 of the receiver PAM 11, through the HVAC return ductwork 52 of the lid PAM 13, through the HVAC return ductwork of the roof PAM 15 and then into the AHU pod 19 via the HVAC return connection 31. Air can also be extracted from the auxiliary rooms 7 of the operating theatre facility 3 via the extraction ducts 66 provided in the HVAC return ductwork 57 of the receiver PAM 11.

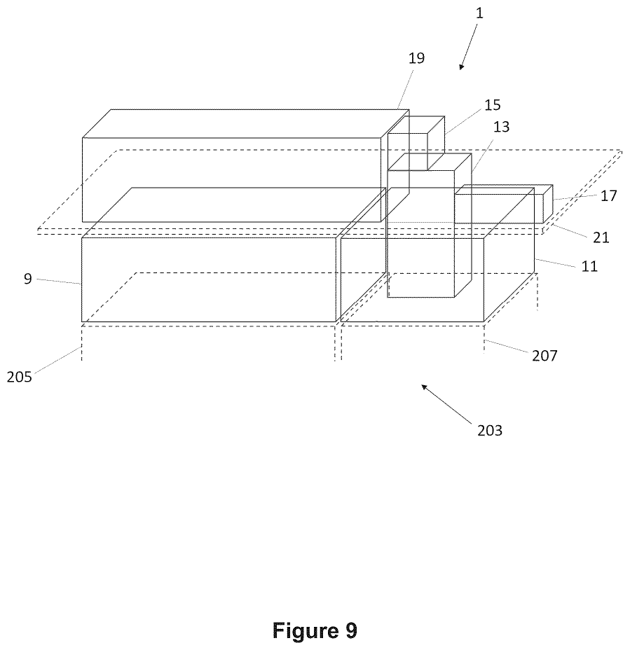

In an alternative embodiment of the present invention, the service network 1 can be used in combination with a modular operating theatre facility 203 which comprises a separate operating theatre pod 205 and a separate auxiliary rooms pod 7, as shown in FIG. 9. The auxiliary rooms pod 7 services the operating theatre pod 5 and the auxiliary rooms pod 7 typically comprises a preparation/layup room, an anaesthetic room and a scrub/gown room. The operating theatre pod 205 and the auxiliary rooms pod 207 are independent pre-fabricated modules that are located adjacent to each other and which are connected together such that, in use, medical staff can pass between them. The operating theatre pod 205 and the auxiliary rooms pod 207 are each generally in the shape of a cuboid (but they can be generally in the shape of a cube).

In a further alternative embodiment of the present invention, the service network 1 can be used in combination with a robotic operating theatre facility (not shown). A robotic operating theatre facility will be set up differently, for example it might not have an ultra-clean ventilation canopy.

1. A service network system (1), for providing services to an operating theatre facility (3), comprising, an air handling unit (19), an interface pre-assembled module (13), a receiver pre-assembled module (11), an operating theatre pre-assembled module (9), ventilation supply ductwork (50,55,77) and ventilation return ductwork (52,57,79), wherein the ventilation supply ductwork (50, 55,77) and ventilation return ductwork (52, 57,79) pass from the air handling unit (9) then through the interface pre-assembled module (13), then through the receiver pre-assembled module (11) and then into the operating theatre pre-assembled module (9).

2. A service network system (1) as claimed in claim 1, wherein the operating theatre facility (3) is located within a building and wherein the air handling unit (19) is located outside of the building, the interface pre-assembled module (13) is located in an external surface of the building such that it has a first part (35) that is located outside of the building and a second part (37) that is located inside of the building, the receiver pre-assembled module (11) is located within the building and the operating theatre pre-assembled module (9) is located within the building, wherein the ventilation supply ductwork (50, 55,77) and ventilation return ductwork (52, 57,79) pass through the interface pre-assembled module (13).

3. A service network system (1) as claimed in claim 2, wherein the air handling unit (19) is located on the roof of the building and vertically above the operating theatre pre-assembled module (9), wherein the operating theatre pre-assembled module (9) and the receiver pre-assembled module (11) are located adjacent to each other and the ventilation supply ductwork (55,77) and the ventilation return ductwork (57,79) run laterally between the operating theatre pre-assembled module (9) and the receiver pre-assembled module (11).

4. A service network system (1) as claimed in claim 1, wherein the interface pre-assembled module (13) is a lid pre-assembled module (13).

5. A service network system (1) as claimed in claim 1, wherein the operating theatre pre-assembled module (9) is provided with a ultra-clean ventilation canopy opening (89) and HVAC supply ductwork for connection to an ultra-clean ventilation canopy (91).

6. A service network system (1) as claimed in claim 5, wherein an ultra-clean canopy (91) is provided within the ultra-clean ventilation canopy opening (89) and is connected to the HVAC supply ductwork.

7. A service network system (1) as claimed in claim 1, wherein all services provided to the operating theatre pre-assembled module (9) pass through a vertical face of the operating theatre pre-assembled module (9).

8. A service network system (1) as claimed in claim 7, wherein all of the services that are provided to the operating theatre pre-assembled module (9) pass through the receiver pre-assembled module (11).

9. A service network system (1) as claimed in claim 1 wherein the operating theatre pre-assembled module (9) is provided with a lamp pendant support (95).

10. A service network system (1) as claimed in claim 1 wherein the operating theatre pre-assembled module (9) is provided with a first pendant support (97), a second pendant support (99) and a third pendant support (101).

11. A service network system (1) as claimed in claim 1, wherein the receiver pre-assembled module (11) and the operating theatre pre-assembled module (9) each comprise an open framework (51, 73).

12. A service network system (1) as claimed in claim 1, for providing services to an ultra-clean operating theatre facility (3,203).

13. A service network system (1) as claimed in claim 1, in combination with an operating theatre facility (3,203).

14. A service network system (1) as claimed in claim 13, wherein the operating facility (203) comprises a separable operating theatre pod (205) and a separable auxiliary rooms pod (7).

15. A service network system (1) as claimed in claim 1, in combination with an ultra-clean operating theatre facility (3,203).

16. A service network system (1) as claimed in claim 15, wherein the ultra-clean operating facility (203) comprises a separable operating theatre pod (205) and a separable auxiliary rooms pod (207).
